(19) United States
(12) Patent Application Publication
(10) Pub. No.: US 2024/0406319 A1
(43) Pub. Date: Dec. 5, 2024

(54) INFORMATION PROCESSING DEVICE AND DISPLAY METHOD

(71) Applicant: SHARP KABUSHIKI KAISHA, Sakai City (JP)

(72) Inventor: TSUYOSHI NAGAO, Sakai City (JP)

(21) Appl. No.: 18/676,727

(22) Filed: May 29, 2024

(30) Foreign Application Priority Data
May 31, 2023 (JP) 2023-090237

(51) Int. Cl. H04N 1/00; H04N 1/23; H04N 1/32

(52) U.S. Cl. CPC H04N 1/0023; H04N 1/2392; H04N 1/32582; H04N 1/32587; H04N 2201/0094

(57) ABSTRACT

An information processing device includes a display device that displays information, and a controller, wherein the controller executes a standard application that causes a basic function of the information processing device to operate, and an additional application that causes an operation that adds a function other than the basic function to the information processing device, the standard application preferentially displays, when a predetermined notification has been acquired from the information processing device, a message based on the notification as a first window on the display device, the additional application displays predetermined information according to processing as a second window on the display device, and the additional application acquires display information relating to the first window, and determines a design of the second window based on the display information.

### CROSS-REFERENCE TO RELATED APPLICATION

The present application claims priority from Japanese Application JP2023-90237, the content of which is hereby incorporated by reference into this application.

### BACKGROUND OF THE INVENTION

### 1. Field of the Invention

The present disclosure relates to an information processing device and the like.

### 2. Description of the Related Art

For example, in a conventional technique, various improvements have been made to the display method of information processing devices, which include image forming devices.

### SUMMARY OF THE INVENTION

An object of the present disclosure is to provide an information processing device or the like that, for example, is capable of displaying a window with high visibility when displaying information in a window.

An information processing device according to the present disclosure includes a display device that displays information, and a controller, wherein the controller executes a standard application that causes a basic function of the information processing device to operate, and an additional application that causes an operation that adds a function other than the basic function to the information processing device, the standard application preferentially displays, when a predetermined notification has been acquired from the information processing device, a message based on the notification as a first window on the display device, the additional application displays predetermined information according to processing as a second window on the display device, and the additional application acquires display information relating to the first window, and determines a design of the second window based on the display information.

A display method of an information processing device having a display device according to the present disclosure includes: when a standard application that causes a basic function of the information processing device acquires a predetermined notification from the information processing device, preferentially displaying a message based on the notification as a first window on the display device, displaying predetermined information output by an additional application according to processing as a second window on the display device, the additional application being an application that causes an operation that adds a function other than the basic function to the information processing device, and acquiring display information relating to the first window, and determining a design of the second window based on the display information.

According to the present disclosure, it is possible to provide an information processing device or the like that, for example, is capable of displaying a window with high visibility when displaying information in a window.

### BRIEF DESCRIPTION OF THE DRAWINGS

FIG. 1 is a diagram illustrating an outline of a system according to a first embodiment.

FIG. 2 is a diagram illustrating a hardware configuration of an image forming device according to the first embodiment.

FIG. 3 is a diagram illustrating a software configuration according to the first embodiment.

FIG. 4A is a diagram illustrating an example of device information according to the first embodiment, and FIG. 4B is a diagram illustrating an example of design information according to the first embodiment.

FIG. 5A is a diagram illustrating an acquisition method of device information according to the first embodiment, and FIG. 5B is a diagram illustrating an acquisition method of device information according to the first embodiment.

FIG. 6 is a diagram illustrating a display area of a device according to the first embodiment.

FIG. 7A is a diagram illustrating an acquisition method of design information according to the first embodiment, and FIG. 7B is a diagram illustrating an acquisition method of design information according to the first embodiment.

FIG. 8 is a diagram illustrating an acquisition method of design information according to the first embodiment.

FIG. 9 is a flow diagram illustrating the processing of the first embodiment.

FIG. 10 is a diagram illustrating size determination according to the first embodiment.

FIG. 11A is a diagram illustrating an operation example according to the first embodiment, and FIG. 11B is a diagram illustrating an operation example according to the first embodiment.

FIG. 12A is a diagram illustrating an operation example according to the first embodiment, and FIG. 12B is a diagram illustrating an operation example according to the first embodiment.

FIG. 13 is a flow diagram illustrating the processing of a second embodiment.

FIG. 14 is a flow diagram illustrating the processing of the second embodiment.

FIG. 15 is a flow diagram illustrating the processing of a third embodiment.

### DETAILED DESCRIPTION OF THE INVENTION

Hereinafter, embodiments for carrying out the present disclosure will be described with reference to the drawings. Note that the embodiments below are merely examples of the present disclosure, and the content of the present disclosure is not to be construed as limited based on the following description.

In an information processing device, a first application is installed in advance. The first application not only includes pre-installed software, but also includes applications and the like that are integrated with the operating system.

The first application is capable of displaying, for example, a dialog, being a special window, in response to a notification or an interruption from the information processing device. A dialog that displays such a notification or an alert is also sometimes referred to as a pop-up window or an alert window. Hereinafter, a dialog and the like that is used for a notification or an alert will be simply referred to as a window.

Furthermore, a dialog displayed as a window is sometimes displayed by an application that has been added. For example, a second window can be displayed to indicate that an additional application is performing processing, and when an additional application provides a notification to the user.

Here, the first window that is displayed by the information processing device alone (for example, a window displaying the functions of the information processing device itself) and the second window that is displayed by the application that has been added generally have inconsistent designs.

This is because it is not possible to predict what type of information processing device will execute the additional application, and further, the standard application of the information processing device also does not know what type of additional application will be installed.

As a result, because a design that is consistent between the first window and the second window cannot be provided, the display is not easy for the user to understand. An information processing device for solving one or more of the problems described above will be described below.

### 1. First Embodiment

### 1.1 Overall System

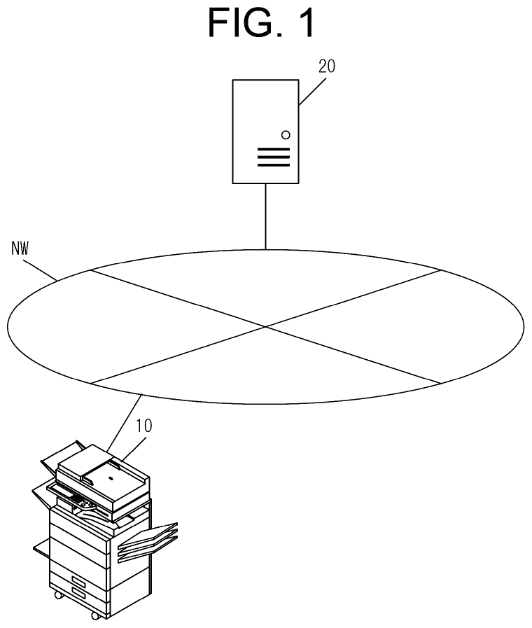

FIG. 1 is a diagram illustrating an outline of a system 1. In the system 1, an image forming device 10, which is an example of an information processing device, is connected to a network NW. The image forming device 10 can, for example, install an application to be added from a server device 20 that distributes applications, and provide new functions.

For example, the image forming device 10 is a device that is referred to as a multifunction peripheral/printer/product (MFP). For example, when executing a job (print job), the image forming device 10 is capable of forming an image on paper, which is a recording medium. The image forming device 10 is capable of executing a plurality of functions, such as a copy function, a fax function, a scan function, and a printer function. In the present embodiment, the image forming device 10 functions as a printer by executing a print job input from a communicable device (for example, a computer, a smartphone, or a tablet). Furthermore, the image forming device 10 is capable of outputting (printing) content by executing a print job based on content selected by the user.

Here, in the present embodiment, although the image forming device 10 will be described as an example of an information processing device, the information processing device may be another type of device. For example, the information processing device may be a device such as a television or a home appliance, a tablet-type terminal device, or an in-vehicle device such as a car navigation system.

Although the details will be described later, the information processing device is a device that can execute an application that has been installed by default (standard application), and is capable of installing and executing an application that has been additionally acquired from an external source (additional application). The standard application is an application (program) that is capable of executing a basic function. The additional application is an application (program) that is capable of executing a function other than the basic function.

### 1.2 Hardware Configuration

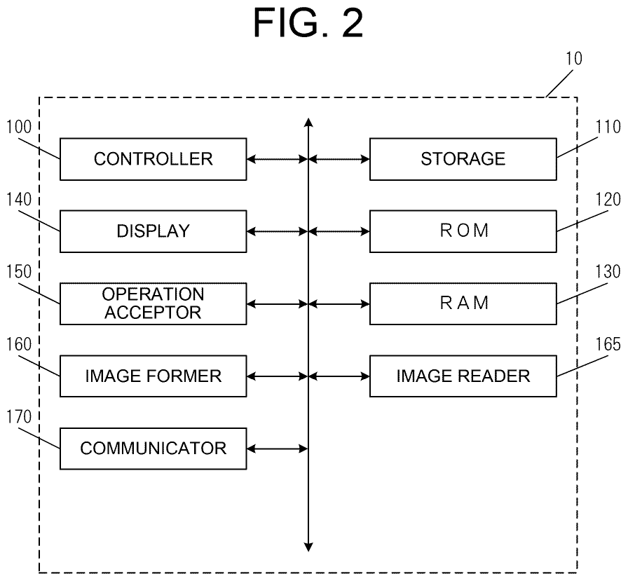

Here, a hardware configuration of the image forming device 10 will be described with reference to the drawings. As illustrated in FIG. 2, the image forming device 10 includes: a controller 100; a storage 110, a ROM 120, and a RAM 130 as storage devices; a display 140; an operation acceptor 150; an image former 160; an image reader 165; and a communicator 170.

The controller 100 is a functional unit that performs overall control of the image forming device 10. The controller 100 realizes various functions by reading and executing various programs stored in the storage 110 and the ROM 120, and may be realized by one or more control devices/arithmetic devices (a central processing unit (CPU) or a system on a chip (SoC)).

The storage 110 is a non-volatile storage device capable of storing programs and data. For example, the storage 110 may be configured by a storage device such as a hard disk drive (HDD) or a solid state drive (SSD). Furthermore, the storage 110 may be configured by a USB memory that can connect to an external source, a compact disc (CD)-ROM drive, or a Blu-ray disc (BD)-drive. In addition, the storage 110 may be, for example, a storage area on the cloud.

The ROM 120 is a non-volatile memory capable of retaining programs and data even when the power is turned off.

The RAM 130 is a main memory that is mainly used when the controller 100 executes processing. The RAM 130 is a rewritable memory that temporarily retains programs read from the storage 110 or the ROM 120, and data including the results of execution.

The display 140 is a display device capable of displaying various pieces of information and execution screens. The display 140 may be, for example, a display device such as a liquid crystal display (LCD), an organic electroluminescence (EL) display, or an electrophoretic display. Furthermore, the display 140 includes an interface to which a display device can connect. For example, the display may be configured by an external display device connected via a high-definition multimedia interface (HDMI) (registered trademark), a digital visual interface (DVI), or a Display Port.

The operation acceptor 150 is an operation device that allows the user to input operations. For example, the operation acceptor 150 may be an operation device such as a touch panel integrated with the display 140, or an operation button. Furthermore, the operation acceptor 150 may be an operation device such as a keyboard or a mouse. Moreover, the operation acceptor 150 may include an interface (for example, a universal serial bus (USB)) to which an operation device can connect. For example, different operation devices (operation devices with a touch panel) may be connected to the image forming device 10.

The image former 160 forms an image, for example, on recording paper. The image former 160, for example, includes an image carrier, forms a toner image on the image carrier, and transfers the image on the image carrier onto the recording paper, thereby forming an image. The image former 160 may be configured as an image forming device such as a printer. Furthermore, the image former 160 may electronically form an image as an image file.

The image reader 165 reads a document (image), and outputs the document as image data. The image reader 165 is, for example, a scanner, and may be a reading device using a charge coupled device (CCD) or a contact image sensor (CIS).

The communicator 170 is a communication interface that communicates with other devices. For example, the communicator 170 may be a network interface capable of providing a wired connection or a wireless connection. In the present embodiment, communication with other devices is possible via the network NW.

Note that the functional configuration of the device described in FIG. 2 is an example. The functional units may be added or omitted as necessary. Furthermore, for example, the display 140 and the operation acceptor 150 may be integrally formed as a touch panel.

### 1.3 Software Configuration

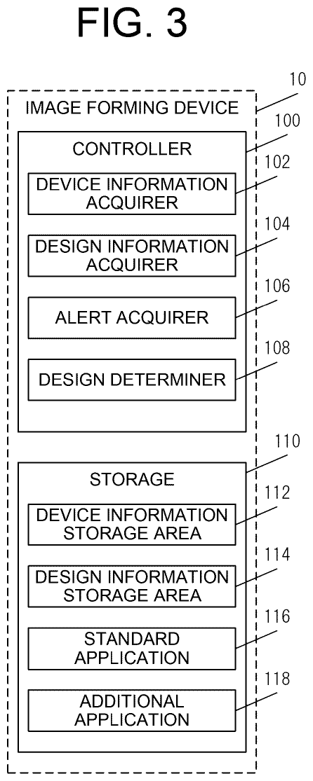

The configuration of the software in the image forming device 10 will be described with reference to FIG. 3.

The controller 100 of the image forming device 10 realizes various functions by executing programs (applications) stored in the storage 110 or the ROM 120.

The controller 100 realizes various processing by reading and executing applications stored in the storage 110. In the present embodiment, a standard application 116 and an additional application 118 are described as examples of applications. Note that, in the description below, a reference simply to an application may apply to either of the applications.

Here, the standard application 116 is an application that causes a basic function of the image forming device 10 to operate, and is installed in advance in the image forming device 10. Furthermore, the additional application is an application that is additionally installed, and is an application that performs an operation that adds a function other than the basic function. Here, the basic function is a function is a function that is provided in advance when the image forming device 10 operates. For example, when the image forming device 10 implements a copy function, the basic function is an application that is provided as a copy function, and is a function that can be executed by simply turning on the power. Similarly, when a facsimile function is implemented, the basic function is a function that is necessary for executing facsimile communication. Further, when a scanner function is implemented, the basic function is a function that is necessary for executing scan processing.

In this way, the standard application 116 and the additional application 118 may, for example, be distinguished according to the timing of installation in the image forming device 10. Furthermore, each of the applications may have a plurality of applications installed.

The controller 100 executes processing specific to the image forming device 10 by executing the standard application 116 that is stored in the storage 110. For example, the standard application 116 may be an application that is built into an operating system (OS) that is executed by the image forming device 10. Moreover, the standard application 116 is a pre-installed application that is executed by the image forming device 10.

Here, when the standard application 116 acquires an alert from an alert acquirer 106, the standard application 116 displays a window (such as a dialog or a popup) that notifies information on the display 140.

The alert acquirer 106, for example, acquires an alert relating to operation of the hardware of the image forming device 10, and transmits the alert to a predetermined application. For example, when the standard application 116 receives an alert from the alert acquirer 106, the standard application 116 displays a first window as a notification based on the alert on the display 140. The first window has a high priority, and therefore, is preferentially displayed. For example, the standard application 116 is displayed in a top layer (frontmost layer) of the information that is currently being displayed on the display 140. As a result, the first window that is displayed by the standard application is preferentially displayed compared to other windows, other information, and the like.

Here, it is plausible for alerts such as the following to be acquired by the alert acquirer 106.
(1) An alert when a physical operation is performed on the image forming device 10. For example, the user has opened the front panel, the user has opened the rear panel, or the user has opened the paper feed tray.
(2) An alert when an error is detected in the image forming device 10. For example, a paper jam has occurred, or the waste toner box is full.
(3) An alert relating to a consumable item in the image forming device 10. For example, the paper has run out, the toner has run out, the toner has nearly run out, or the staple blades have run out.

Note that the alert acquirer 106 can acquire an alert based on an interruption from the image forming device 10. The alert acquirer 106 may, for example, acquire not only alerts relating to operation of the hardware, but also alerts relating to operation of the software. For example, the alert acquirer 106 may acquire an alert such as a software update alert, a security alert, and the like.

The controller 100 can execute the additional application 118 stored in the storage 110. The additional application 118 is an application that is not installed when the image forming device 10 is shipped, or in an initial state. The additional application 118 is capable of executing a function other than the basic function executed by the standard application 116. For example, the user may download and install the additional application from the server device 20. Furthermore, the additional application 118 may be installed by a service person when setting up the image forming device 10.

During execution of the additional application, the controller 100 notifies the information required in the additional application by displaying a second window. Here, the design of the second window is determined by a design determiner 108. The operation of the design determiner 108 will be described later.

Moreover, when the design determiner 108 determines the window design, the controller 100 acquires display information as reference information. Here, the window design includes the shape, size, and color of the window. In addition, the display information is information that can be referred to when an application displays a window. For example, the display information may include device information relating to the display device, and design information relating to attributes when determining the window design.

First, a device information acquirer 102 acquires device information as one piece of the display information. Furthermore, a design information acquirer 104 acquires design information as one piece of the display information.

When the controller 100 executes an application (for example, the additional application 118), the device information acquirer 102 and the design information acquirer 104 may be executed when the application is started. Moreover, the device information acquirer 102 and the design information acquirer 104 may acquire the display information as necessary while the controller 100 is executing the application.

Here, for example, the device information is information that is stored in advance in the image forming device 10. The device information is stored in a device information storage area 112.

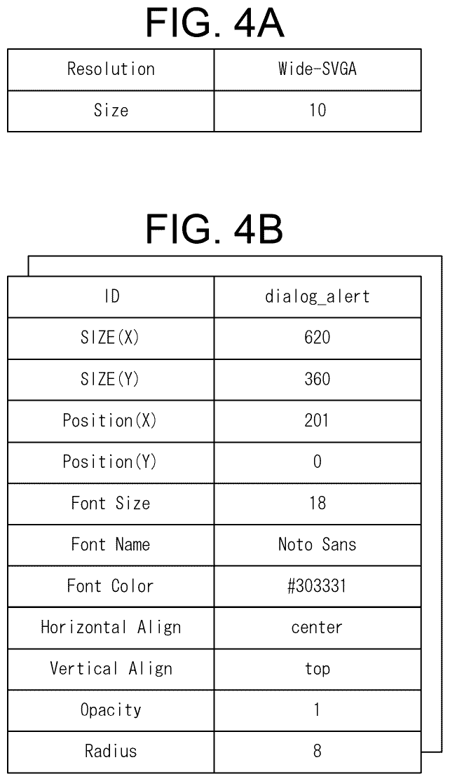

FIG. 4A is a diagram illustrating an example of the device information. The device information may store a resolution of the display device (for example, the display 140). As the resolution, VGA, SVGA, XGA, Wide-VGA, Wide-SVGA, Wide-XGA, and the like, may be stored. The display device (display 140) may be an operation panel.

Furthermore, the device information may store, for example, the size of the display device (display 140) in inches. For example, the device information may store numerical values such as 7 inches, 9 inches, 10 inches, and 15 inches based on the diagonal size of the display device.

In addition to this, the device information may also store the model number of the display device or the number of displayable dots.

Moreover, although the device information shown in FIG. 4A includes the resolution and the size of the display device, it is possible to store only one of the pieces of information, or to store additional pieces of information.

The device information acquirer 102 may be executed, for example, when an application is started, such that the device information is acquired from values notified by the image forming device 10 to the application.

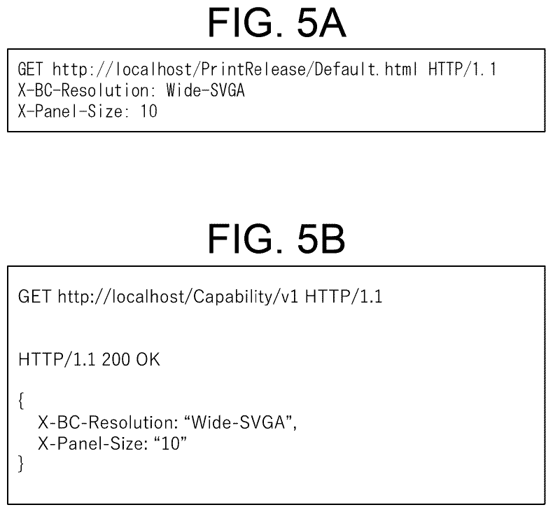

For example, FIG. 5A and FIG. 5B are diagrams illustrating an example of the device information acquirer 102 acquiring the device information. In FIG. 5A, the image forming device 10 notifies information to an application to be executed. For example, the additional application 118 can obtain the device information as shown in FIG. 5A.

Furthermore, an application may query the image forming device 10 for the device information during initialization processing when starting up.

For example, when starting up, as shown in FIG. 5B, the additional application 118 uses a GET command to acquire the device information. The image forming device 10 can return the device information to the additional application 118 as a return value.

For example, the design information is information that is stored in advance by the image forming device 10, and includes attributes relating to the window design. The design information is stored in a design information storage area 114.

The design information storage area 114 may store the design information relating to the first window that is displayed by the standard application 116 in advance. Furthermore, the design information storage area 114 may store the design information relating to the second window that is displayed by the additional application 118. In addition, the design information may store design information for each type of window that is displayed by an application.

Moreover, in the present embodiment, although the design information will be described as being stored in the design information storage area 114, each application may store design information individually. An application may store the design information within the application, or may store the design information in an individual or shared settings file. In addition, the design information may be stored in the settings information of the image forming device 10 or a settings file (such as a registry file) in the information processing device.

FIG. 4B is a diagram illustrating an example of the design information. The design information stores, for example, the following information (attributes).
The ID representing the window (for example, “dialog_alert” indicating the type of warning dialog)
The horizontal size of the window shape (for example, “620” as SIZE (X))
The vertical size of the window shape (for example, “360” as SIZE (Y))
The horizontal position of the left corner origin of the window position (for example, “201” as Position (X))
The vertical position of the left corner origin of the window position (for example, “0” as Position (Y))
The text size displayed in the window (for example, “18” as Font Size)
The text font displayed in the window (for example, “Noto Sans” as Font Name)
The text color displayed in the window (for example, “#303331” as Font Color)
The horizontal direction adjustment method of the window (for example, “center” as Horizontal Align)
The vertical direction adjustment method of the window (for example, “top” as Vertical Align)
The transparency of the window (for example, “1” as Opacity)
The corner rounding radius of the window (for example, “8” as Radius)

One or more of these pieces of information are stored.

The design information illustrated in FIG. 4B are attributes that are used to display the first window, which is displayed when the standard application 116 is executed. When the first window is displayed by the standard application 116 on the display 140, the controller 100 acquires the design information, and displays the first window with the attributes according to the design information.

When the second window is displayed by the additional application 118 on the display 140, the controller 100 may display the second window with attributes according to the design information stored in the design information storage area 114. In addition, when the additional application 118 stores the design information, the controller 100 may display the second window according to such design information.

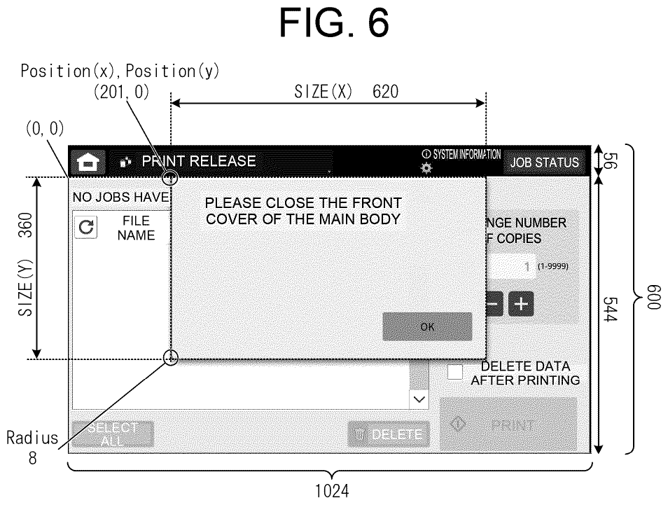

Note that FIG. 6 is a diagram illustrating the correspondence between the displayed window and the design information (window attributes) illustrated in FIG. 5B. In this way, the standard application 116 displays the first window based on the design information. Furthermore, the additional application 118 displays the second window based on the design information.

The design information acquirer 104 is executed as appropriate when an application is started or when an application is executed. The design information acquirer 104 transmits, to an application, the design information of the window to be displayed by the application.

Furthermore, information about the display area illustrated in FIG. 6 may also be used as the device information. For example, a horizontal size of 1,024, and a vertical size of 600 may also be used as the device information.

Moreover, the coordinates in which a window (dialog) is displayed may be set so as to be about an area that enables the image forming device 10 to display a menu or the like. For example, in the case of FIG. 6, 56 pixels are secured at the top of a notification area, and the area below that is capable of displaying information has a height of 544 pixels. Therefore, in terms of the coordinates of the area displaying the window, the coordinates (such as the Y coordinate, which is the height) of the area that is capable of displaying information may be set to an initial coordinate of 0. In addition, the area that displays the window mentioned above may be set to the size in the device information.

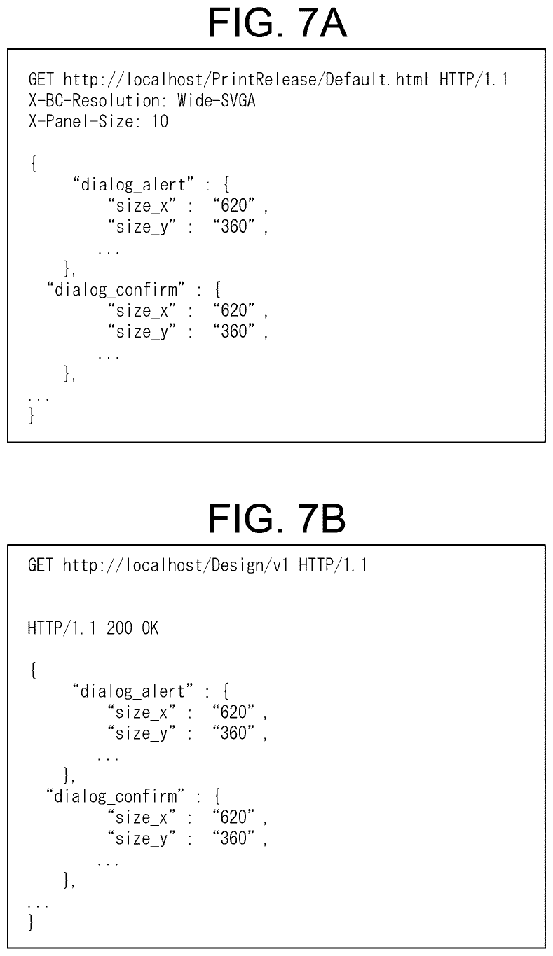

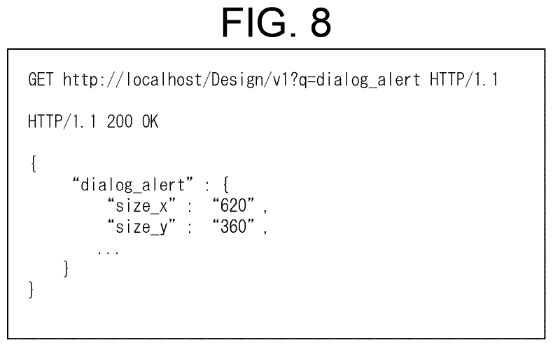

An example of a method by which the design information acquirer 104 acquires the design information will be described with reference to FIGS. 7 and 8. For example, when an application is being executed, the image forming device 10 transmits the design information to the application. For example, as illustrated in FIG. 7A, the design information acquirer 104 can acquire the design information.

Moreover, the design information acquirer 104 may query the image forming device 10 for the design information when an application is executed. For example, in FIG. 7B, the design information acquirer 104 acquires the design information from the image forming device 10.

For example, “http://localhost/Design/v1 HTTP/1.1” and a command are transmitted to the image forming device 10 using a GET command. The image forming device 10 returns the design information as a return value in an HTTP response.

Note that an application may acquire only a specific window design as necessary. For example, in FIG. 8, the GET command specifies “q-dialog_alert” as an argument (parameter). In this case, the image forming device 10 returns the design information having the ID “dialog_alert”.

Note that the device information acquirer 102 and the design information acquirer 104 may be implemented in an application. For example, the device information acquirer 102 and the design information acquirer 104 may be implemented in the additional application 118. Furthermore, the device information acquirer 102 and the design information acquirer 104 may be implemented in the standard application 116.

In addition, the standard application 116 may include the device information and/or the design information in an application in advance. Because the standard application 116 is an application that is executed by the image forming device 10, the device information and/or the design information may be stored in advance.

### 1.4 Processing Flow

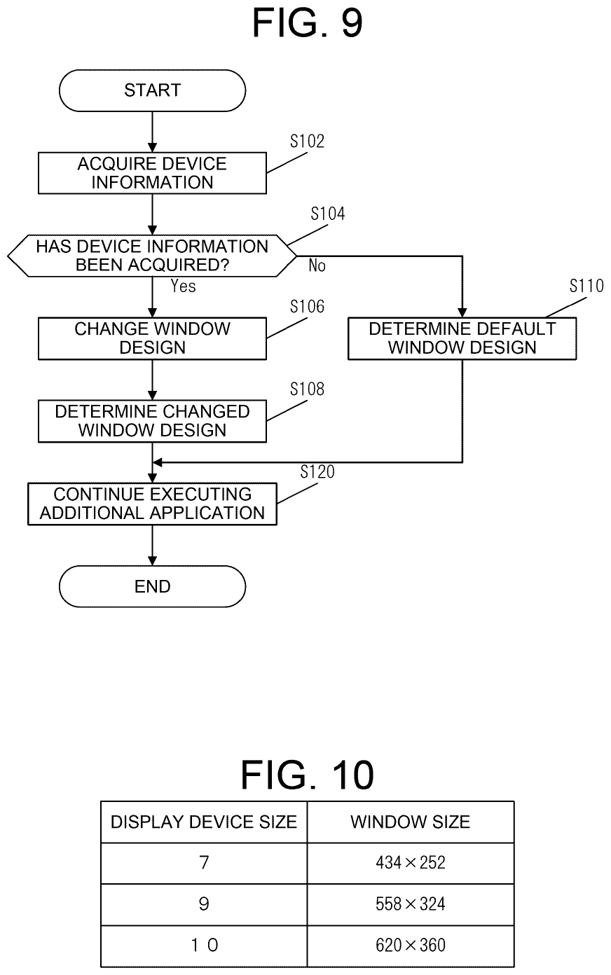

Next, the processing flow of the present embodiment will be described. FIG. 9 is a diagram illustrating the processing flow that is carried out during execution of the additional application 118. For example, when the additional application 118 is executed, the controller 100 may execute initialization processing or pre-processing as necessary.

First, the controller 100 acquires the device information (step S102). Here, when the controller 100 is able to acquire the device information, for example, the controller 100 may temporarily store the device information in the storage 110 or the RAM 130. Furthermore, the device information may be stored in a storage area included in the additional application 118.

Next, when the device information is able to be acquired, the controller 100 changes the window design that is displayed by the additional application 118 (step S106). Here, the design of the second window of the additional application 118 to be changed may, for example, be the design information that is stored by the additional application 118, or may be stored in predetermined settings information (such as a registry).

Here, the design determiner 108 determines the design such that the second window that is displayed by the additional application 118 is less than or equal to the first window that is displayed by the standard application 116.

As a result, when displayed, the first window is displayed preferentially over (in front of) the second window. Further, as a result of the size of the first window, which is preferentially displayed, being greater than or equal to the size of the second window, the second window that is already displayed becomes hidden due to the first window, which creates a sense of integration as a design.

Here, in the present embodiment, the controller 100 executes processing that determines a second window size according to the device information. For example, as illustrated in FIG. 10, the controller 100 may determine the window size (second window size) according to the size of the display 140, which is a display device, as an example of the device information. Furthermore, for example, when the controller 100 acquires the size of the display 140 of “9 inches” from the device information acquired from the device information acquirer 102, the controller 100 may determine the size of the second window as having a horizontal size of “558” dots, and a vertical size of “324” dots.

The image forming device 10 may store the size of the second window as a size that causes the second window size to be smaller than a first window size. In addition, the additional application may store data and programs that enable the response illustrated in FIG. 10.

Moreover, although FIG. 10 uses the size of the display 140 as the device information, it is also possible to use the resolution. Also, FIG. 10 has been described using a table as an example. It is possible to calculate the size of the second window based on a ratio with respect to a reference size (for example, a size of 0.9 times the reference size).

Furthermore, as illustrated in FIG. 10, the controller 100 changes the horizontal size and the vertical size as attributes of the second window. However, other attributes relating to the window design may also be changed. For example, the controller 100 may also change a Radius value representing the rounding of the corners of the window as an attribute of the window design.

The controller 100 determines that the window design changed in step S106 will be used when the additional application 118 is executed (step S108). As a result, although the additional application 118 continues to execute the subsequent processing (step S120), the second window that is displayed during execution uses the window design that has been determined in step S108.

Note that the controller 100 determines that the default window design will be used as is when the device information is unable to be acquired (step S104: No→step S110).

### 1.5 Operation Example

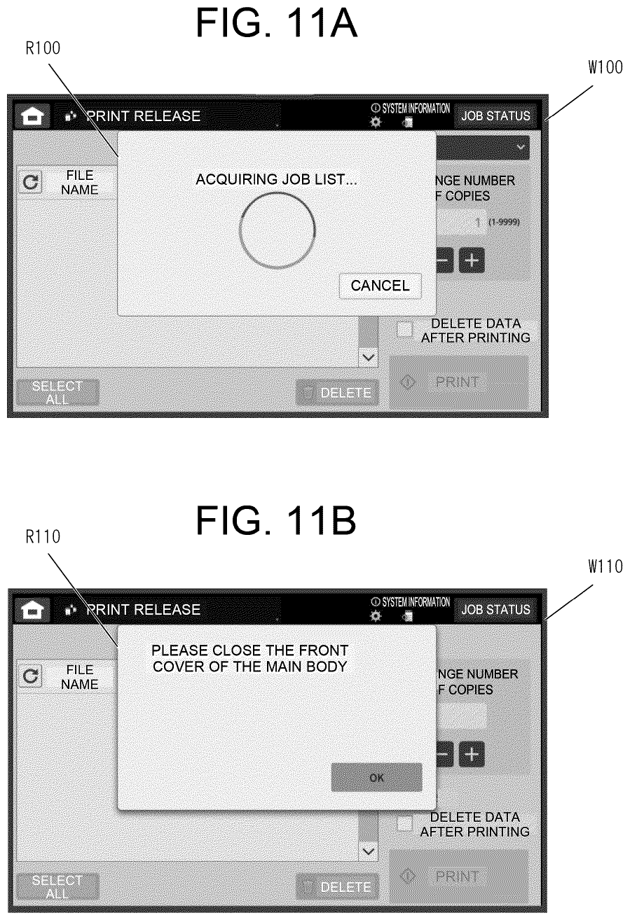

Hereinafter, an operation example will be described with reference to diagrams illustrating the display screen. FIG. 11A is an example of a display screen W100 when the additional application 118 is executed.

The additional application 118 displays the second window on the display screen W100 as necessary. For example, in FIG. 11A, a second window R100 that presents information to the user that a job list is being acquired is displayed superimposed on the main display screen W100.

At this time, when front cover of the main body of the image forming device 10 is opened by the user, the alert acquirer 106 acquires an alert indicating that the cover has been opened. This alert is acquired by the standard application 116, which displays the first window indicating the alert to the user.

FIG. 11B is a display screen W110 illustrating a state where a first window R110 is displayed superimposed. In FIG. 11B, only the first window is displayed. Then, when the user closes the front cover of the main body, the first window is no longer displayed (the display disappears). That is, the display returns to the state in FIG. 11A.

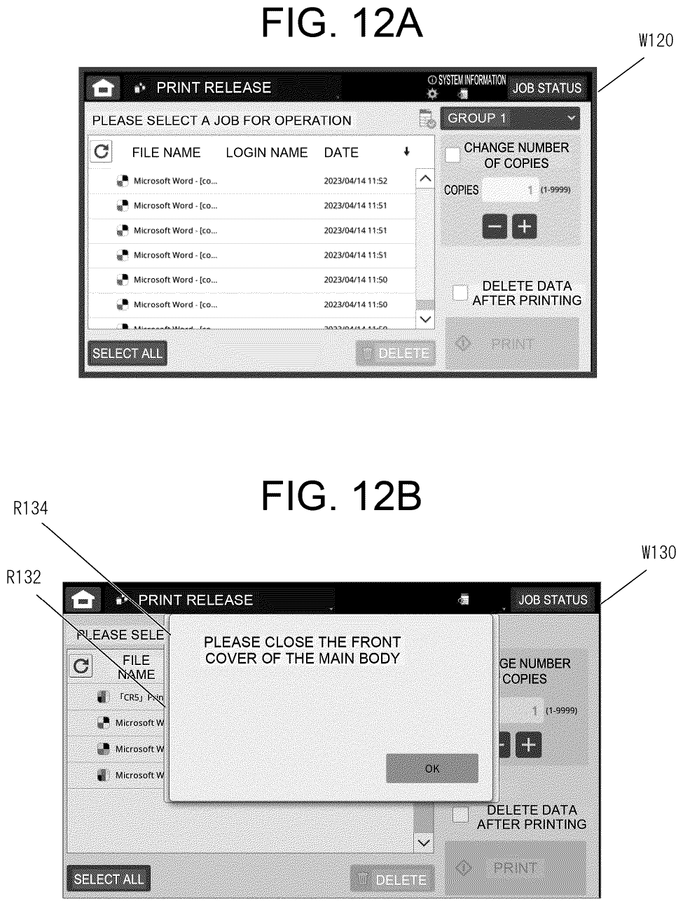

Then, when acquisition of the job list illustrated in FIG. 11A is completed, the additional application 118 no longer displays the second window (the display disappears). That is, the display shifts to the state of a display screen W120 in FIG. 12A.

At first glance, although the display screen W110 in FIG. 11B illustrates a state that is simply displaying only the first window, it is a state that is providing high visibility to the user as a result of applying the present embodiment. Furthermore, the design characteristics are improved compared to a state in which the present embodiment has not been applied. That is, even when the first window is displayed while the second window is being displayed on the display screen, the second window is not visible to the user, which enables the design to have a sense of integration.

For example, FIG. 12B is a diagram illustrating a display screen W130 when the present embodiment is not applied. When the controller 100 displays a first window R134 when a second window R132 is being displayed without consideration of the window size, a state of the display occurs in which one window is displayed stacked on the other window. Furthermore, the design (rounding) of the corners of the windows is different.

In this way, the first window that has been displayed by the standard application 116 and the second window that has been displayed by the additional application 118 are displayed in a state where the window designs are not consistent, because the vertical and horizontal widths, and the rounding of the corners of the windows are different. As a result, it appears to the user as though separate functions are each displaying windows.

However, in FIG. 11B, the design of the first window that has been displayed by the standard application 116 and the second window that has been displayed by the additional application 118 is consistent, which enables the windows to be viewed in an integrated manner.

Because the second window is the window displayed by the additional application 118, the size of the window design changes depending on the execution environment. Furthermore, because of the environment in which the additional application 118 is executed (such as the size and resolution of the display device), consistency of the design with the windows executed by the image forming device 10 was conventionally not considered.

In this way, according to the present embodiment, the second window design can be changed based on the display information (such as the device information of the display device) of the image forming device 10. As a result, it is possible to provide a responsive design as the window design that is displayed by the additional application 118.

### 2. Second Embodiment

Next, a second embodiment will be described. In the present embodiment, an embodiment will be described in which, in addition to the device information, design information is used as the display information to change the window design that is displayed by an application.

Note that the present embodiment will be described with a focus on the differences in the configuration and processing from the first embodiment, and drawings and descriptions that are common to the first embodiment will be omitted.

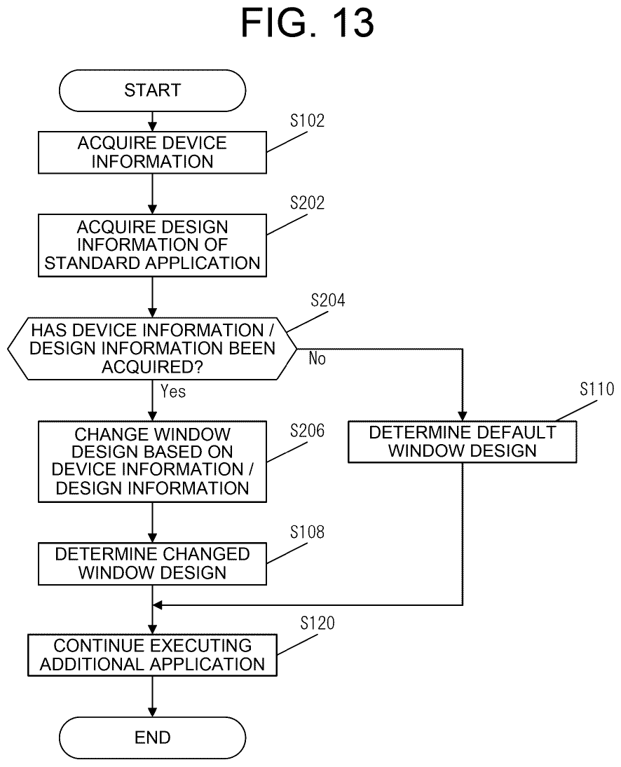

FIG. 13 is a diagram that replaces the processing flow shown in FIG. 9 of the first embodiment. The same processing is given the same reference numeral, and the description will be omitted.

When the additional application 118 is executed, the controller 100 (device information acquirer 102) acquires the device information (step S102). Furthermore, the controller 100 (design information acquirer 104) acquires the design information of the first window that is displayed by the standard application 116 (step S202). Here, the design information that is acquired by the design information acquirer 104 is, for example, the required attributes among the design information illustrated in FIG. 4B.

Here, when the controller 100 (design determiner 108) is able to acquire the device information and the design information, the controller 100 changes the window design of the second window based on the respective information (step S204: Yes→step S206).

Here, the controller 100 changes the window design based on the respective combinations of the acquired information.
(1) When both the device information and the design information were able to be acquired, the controller 100 refers to the two types of information to change the design of the second window.
(2) When only the device information was able to be acquired, the controller 100 refers to the device information to change the design of the second window (first embodiment).
(3) When only the design information was able to be acquired, the controller 100 refers to the design information to change the design of the second window.

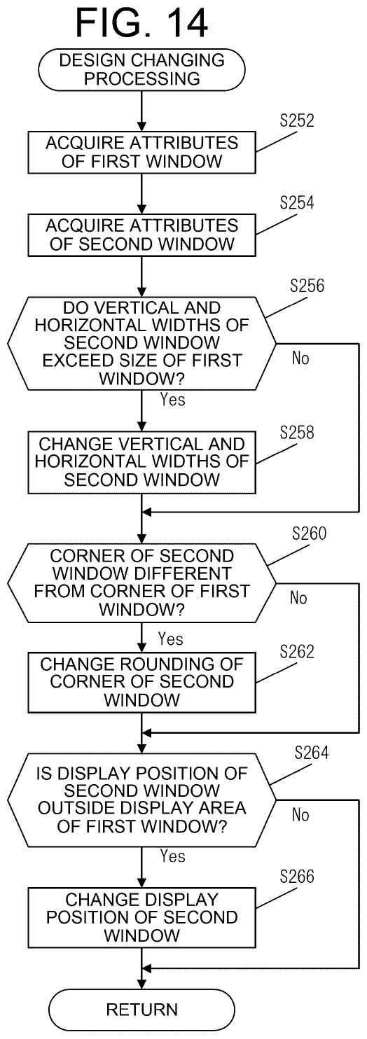

Here, the processing by which the controller 100 (design determiner 108) changes the design of the second window based on the design information will be described with reference to FIG. 14.

FIG. 14 is an operation flow illustrating the processing that causes the size of the second window to be less than or equal to the size of the first window.

First, the controller 100 (design determiner 108) acquires the attributes of the first window that is displayed by the standard application 116 (step S252). Furthermore, the controller 100 acquires the attributes of the second window that is displayed by the additional application 118 (step S254).

After acquiring the attributes of the two windows, the controller 100 determines whether or not the vertical and horizontal widths of the second window exceed the size of the first window. For example, the controller 100 determines whether or not the vertical width of the second window exceeds the vertical width of the first window (step S256). In addition, the controller 100 determines whether or not the horizontal width of the second window exceeds the horizontal width of the first window (step S256).

Here, when the vertical and horizontal widths of the second window exceed the size of the first window, the controller 100 changes the vertical and horizontal widths (size) of the second window (step S258).

For example, the controller 100 compares Size_1(X), which is an attribute representing the horizontal size of the first window, and Size_2(X), which is an attribute representing the horizontal size of the second window, and changes Size_2(X) such that Size_1(X)≥Size_2(X).

Similarly, the controller 100 compares Size_1(Y), which is an attribute representing the vertical size of the first window, and Size_2(Y), which is an attribute representing the vertical size of the second window, and changes Size_2(Y) such that Size_1(Y)≥Size_2(Y).

Then, the controller 100 determines whether or not the corner attribute of the second window is different to the corner attribute of the first window (step S260).

Here, when the corner attribute of the second window and the corner attribute of the first window are different, the controller 100 performs a change that causes the corner of the second window to be hidden by the first window (step S260: Yes→step S262).

For example, when Radius_1, which is an attribute representing the radius of the rounding of the corners of the first window, and Radius_2, which is an attribute representing the radius of the rounding of the corners of the second window, are different, the controller 100 changes Radius_2 to be the same as Radius_1. Here, the second window only needs to be hidden by the first window. For example, the controller 100 may perform a change such that Radius_1≤Radius_2.

Next, the controller 100 determines whether or not the display position of the second window is outside the display area of the first window (step S264).

When the display position of the second window is outside the display area of the first window, the controller 100 changes the display position of the second window so as to be inside the display area of the first window (step S264: Yes→step S266).

For example, the controller 100 compares Position_1(X), which is an attribute representing the horizontal position of the left corner origin of the first window, and Position_2(X), which is an attribute representing the horizontal position of the left corner origin of the second window, and performs a change such that Position_1(X)≤ Position_2(X). Furthermore, the controller 100 compares Position_1(Y), which is an attribute representing the vertical position of the left corner origin of the first window, and Position_2(Y), which is an attribute representing the vertical position of the left corner origin of the second window, and performs a change such that Position_1(Y)≤ Position_2(Y).

Note that the controller 100 may add the horizontal size and the vertical size of the window to the coordinates of the left corner origin, which is the upper left of the window, and calculate the coordinates of the right corner end point, which is the lower right of the window. Further, the controller 100 may adjust the display position of the second window so as to be included in the display area of the first window. At this time, the controller 100 may not only simply adjust the display position, but also execute processing that once again changes the vertical and horizontal widths.

In addition, when the device information is able to be acquired, the controller 100 may also change the design of the second window with the device information. For example, the controller 100 may change the window design by executing the processing in FIG. 9 of the first embodiment, and then execute the processing in FIG. 13.

As described above, according to the present embodiment, the size of the second window can be changed so as to be hidden by the size of the first window.

Furthermore, because the design of the second window is changed using the design information of the first window, it is possible to more accurately change the design of the second window.

Note that an attribute such as the changed size of the second window may be stored as a new second window size by the additional application 118. As a result, it is possible for the second window to be displayed with an appropriate size when the controller 100 executes the additional application 118, and the additional application 118 displays the second window.

### 3. Third Embodiment

Next, a third embodiment will be described. In the present embodiment, a program will be described that executes processing that changes the window design each time a window is displayed.

Note that the present embodiment will be described with a focus on the differences in the configuration and processing from the first embodiment, and drawings and descriptions that are common to the first embodiment will be omitted.

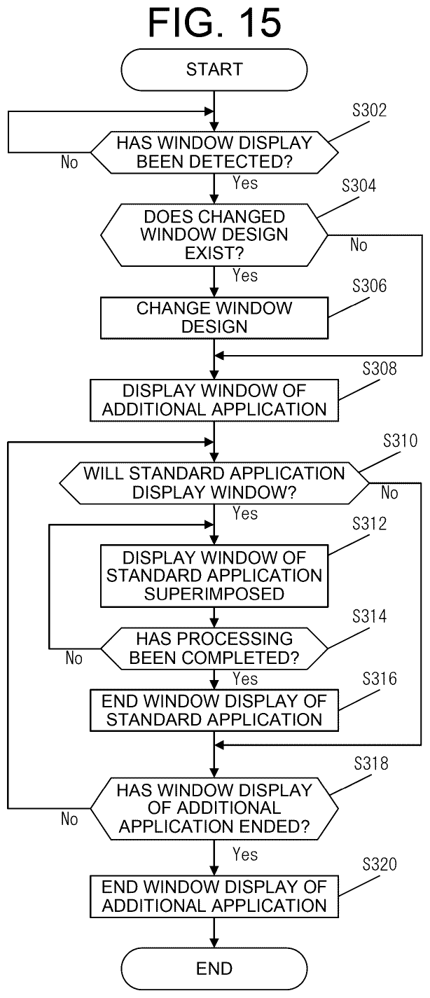

For example, a window design changing program that executes the processing illustrated in FIG. 15 is executed in the image forming device 10.

Here, when the controller 100 detects that an application is displaying a window (step S302: Yes), the controller 100 determines whether or not there is a window design that has been changed in the application (step S304).

Here, the changed window design may be separately stored as a definition file, or may be stored as settings information (such as a registry) and the like. Furthermore, a changed design of the second window that is displayed by the additional application 118 may be acquired as a result of executing the embodiment described above.

When there is a changed window design, the controller 100 changes the window design (step S304: Yes→step S306), and displays the second window that is displayed by the additional application 118 (step S308).

When the controller 100 detects that the standard application 116 will display the first window (step S310: Yes), the controller 100 displays the first window of the standard application 116 superimposed on the current display screen (step S312).

Note that when the processing that releases the state of displaying the first window is completed (step S314: Yes), the display of the first window ends (step S316). Here, completion of the processing in step S314 may represent resolution of the state that caused the first window to be displayed. For example, the controller 100 determines that the processing has been completed when, for a notification indicating a toner outage, the toner has been refilled, or for a notification indicating that the front cover is open, the front cover has been closed, or for a notification relating to trouble such as a paper jam, the trouble has been resolved.

In addition, when the state of displaying the second window is completed, the controller 100 ends the display of the second window that has been displayed by the additional application 118 (step S318: Yes→step S320). Furthermore, when it is necessary to display the second window, the processing from step S310 is executed once again (step S318: No→step S310).

In this way, according to the present embodiment, even when a plurality of applications are used, for example, when applications created by a third party are used, it is possible appropriately change the design of the windows displayed by the applications using a relationship with the windows displayed by the image forming device 10.

### 4. Modifications

The present disclosure is not limited to the embodiments described above, and various modifications may be made. That is, the technical scope of the present disclosure also includes embodiments that may be obtained by combining technical measures that are modified as appropriate without departing from the gist of the present disclosure.

Furthermore, although the embodiments described above have been described separately for convenience of the description, they can be implemented by being combined to the extent possible. Moreover, the applicant intends to acquire rights to any of the techniques described in the specification through amendments, divisional applications, and the like.

In addition, the programs that operate on the devices in each embodiment are programs that control a CPU and the like (are programs that cause a computer to function) so as to realize the functions of the embodiments described above. Further, the information handled by these devices is temporarily stored in a temporary storage device (for example, a RAM) during processing, and then stored in various storage devices, such as a ROM or an HDD, and is read, corrected, and written by the CPU as necessary.

Here, a recording medium that stores the program may be any of a semiconductor medium (such as a ROM or a non-volatile memory card), an optical recording medium/magneto-optical recording medium (such as a digital versatile disc (DVD), a CD, or a BD (registered trademark)), a magnetic recording medium (such as a magnetic tape or a flexible disc), and the like.

Also, when distributed to the market, the programs can be stored in a portable recording medium before distribution, or transferred to a server computer connected via a network such as the Internet. In this case, of course, a storage device in the server device is also included in the present disclosure.

Furthermore, the data described above may not be stored in the device, but may be stored in an external device and retrieved as appropriate. For example, the data may be stored in a network attached storage (NAS) or on the cloud.

Note that the scope of the present disclosure is not limited to the configurations explicitly described in the specification, and include any combination of the techniques disclosed in the present specification. In the present disclosure, the configurations of the claimed disclosure are described in the appended claims. However, the claims are not intended to exclude configurations from the technical scope on the grounds that the configurations are not described in the claims.

Furthermore, in the specification above, descriptions containing “if” and “when” are used for describing examples and are not for limiting the disclosure to the described contents. The configurations other than those containing “if” and “when” are also disclosed to the extent that would be obvious to a person skilled in the art, and are intended to acquire the right to such configurations.

In addition, the order of processing and the data flow described in the specification is not limited to the order in which they are described. For example, configurations in which part of the processing has been deleted, or the order has been switched are also disclosed, and are intended to acquire the right to such configurations.

Moreover, the functions described in the embodiments are described as being performed by the respective devices, but the functions may be realized by a single device or by using an additional external server.

Moreover, the functional blocks and various features of the device used in the embodiments described above may be implemented or executed using an electronic circuit, such as an integrated circuit or a plurality of integrated circuits. The electric circuit designed to execute the functions described in the present specification may include a general-purpose processor, a digital signal processor (DSP), an application-specific integrated circuit (ASIC), a field-programmable gate array (FPGA), or other programmable logic devices, discrete gates or transistor logic, discrete hardware components, or a combination of these. The general-purpose processor may be a microprocessor or, alternatively, a conventional processor, a controller, a microcontroller, or a state machine. The electrical circuit described above may be configured by a digital circuit or an analog circuit. When advancements in semiconductor technology lead to the emergence of integrated circuit technologies that could replace the current integrated circuits, one or more of the aspects of the present disclosure may be realized using such new integrated circuits.

While there have been described what are at present considered to be certain embodiments of the invention, it will be understood that various modifications may be made thereto, and it is intended that the appended claims cover all such modifications as fall within the true spirit and scope of the invention.

What is claimed is:

1. An information processing device comprising a display device that displays information, and a controller, wherein
the controller executes a standard application that causes a basic function of the information processing device to operate, and an additional application that causes an operation that adds a function other than the basic function to the information processing device,
the standard application preferentially displays, when a predetermined notification has been acquired from the information processing device, a message based on the notification as a first window on the display device,
the additional application displays predetermined information according to processing as a second window on the display device, and
the additional application
acquires display information relating to the first window, and
determines a design of the second window based on the display information.

2. The information processing device according to claim 1, wherein
the second window is displayed in a position that is overlapped by the first window.

3. The information processing device according to claim 2, wherein
when the standard application displays the first window on the display device while the additional application is displaying the second window, a state occurs in which the second window is not visible as a result of the first window being displayed in front of the second window.

4. The information processing device according to claim 1, wherein
a size of a display device is included as the display information, and
the additional application determines a size of the second window according to the size of the display device.

5. The information processing device according to claim 4, wherein
the additional application stores a vertical size or a horizontal size of the second window according to the size of the display device.

6. The information processing device according to claim 4, wherein
the additional application displays the second window on the display device in a default size when the display information cannot be acquired.

7. The information processing device according to claim 1, wherein
the additional application determines, based on the display information, a size of the second window so as to be less than or equal to a size of the first window.

8. The information processing device according to claim 1, wherein
a notification acquired by the standard application is a notification from the information processing device based on an operation relating to hardware of the information processing device.

9. The information processing device according to claim 1, wherein
a notification acquired by the standard application is a notification from the information processing device relating to a consumable item of the information processing device.

10. The information processing device according to claim 1, wherein
window information relating to the first window is acquired as the display information, and
the additional application
acquires the window information relating to the first window, and
determines, based on the window information, a size of the second window so as to be less than or equal to a size of the first window.

11. The information processing device according to claim 10, wherein
the additional application acquires, as the window information, information relating to a height and a width of the first window.

12. The information processing device according to claim 10, wherein
the additional application acquires, as the window information, information relating to a shape of a corner of the first window.

13. The information processing device according to claim 10, wherein
the additional application determines, when the display information cannot be acquired, the size of the second window so as to be less than or equal to the size of the first window based on only the window information.

14. The information processing device according to claim 1, wherein
the first window has one or more items arranged therein in a predetermined layout, and
the additional application adjusts the layout when a size of the first window becomes less than or equal to a predetermined size.

15. The information processing device according to claim 14, wherein
the additional application adjusts a layout such that a size of the item does not become less than or equal to the predetermined size.

16. A display method of an information processing device having a display device, the display method comprising:
when a standard application that causes a basic function of the information processing device acquires a predetermined notification from the information processing device, preferentially displaying a message based on the notification as a first window on the display device,
displaying predetermined information output by an additional application according to processing as a second window on the display device, the additional application being an application that causes an operation that adds a function other than the basic function to the information processing device, and
acquiring display information relating to the first window, and determining a design of the second window based on the display information.
